(19) United States
(12) Patent Application Publication
(10) Pub. No.: US 2022/0076466 A1
(43) Pub. Date: Mar. 10, 2022

(54) PROJECTION DEVICE AND PROJECTION METHOD

(71) Applicant: ViewSonic International Corporation, New Taipei City (TW)

(72) Inventors: Jia-Shin Tsai, New Taipei City (TW); Kun-Tsang Yang, New Taipei City (TW); Shun-Chang Chen, New Taipei City (TW)

(73) Assignee: ViewSonic International Corporation, New Taipei City (TW)

(21) Appl. No.: 17/467,470

(22) Filed: Sep. 7, 2021

(30) Foreign Application Priority Data
Sep. 10, 2020 (TW) 109131139

(51) Int. Cl. G06T 11/60; G09G 3/00; G06T 3/40

(52) U.S. Cl. CPC G06T 11/60; G09G 2340/045; G06T 3/40; G09G 3/001

(57) ABSTRACT

A projection device and a projection method are provided. The projection device includes a picture memory, a processor, and a projection module. The picture memory stores at least one mask picture. Each of the at least one mask picture has at least one hollow portion. The processor selects a selected mask picture from the at least one mask picture, and overlays an image with the selected mask picture to generate a masked image. The masked image presents a portion of the image in an area corresponding to the at least one hollow portion. The projection module generates a projection beam corresponding to the masked image.

### CROSS-REFERENCE TO RELATED APPLICATION

This application claims the priority benefit of Taiwanese application no. 109131139, filed on Sep. 10, 2020. The entirety of the above-mentioned patent application is hereby incorporated by reference herein and made a part of this specification.

### BACKGROUND

### Technical Field

The disclosure relates to a projection device and a projection method, particularly to a projection device and a projection method that are capable of providing diverse image output effects.

### Description of Related Art

Generally, a projection device provides a projection beam based on an image to generate a projection image corresponding to the image. However, current projection devices cannot synthesize images. If the projection device wants to play the synthesized image, the image needs to be synthesized in other electronic devices to produce the synthesized image. In addition, if the image needs to be changed, the synthesized image must be re-created in the electronic device. Therefore, the image output effects that the current projection device can provide are quite limited.

### SUMMARY

The present disclosure provides a projection device and a projection method capable of masking images, so that the projection device provides diverse image output effects.

The projection device of the present disclosure includes a picture memory, a processor, and a projection module. The picture memory is configured to store at least one mask picture. Each of the at least one mask picture has at least one hollow portion. The processor is coupled to the picture memory. The processor is configured to select a selected mask picture from the at least one mask picture, receive an image, and overlay the image with the selected mask picture to generate a masked image. The masked image presents a portion of the image in an area corresponding to the at least one hollow portion. The projection module is coupled to the processor. The projection module is configured to generate a projection beam corresponding to the masked image.

The projection method of the present disclosure includes: selecting a selected mask picture from at least one mask picture; receiving an image, and overlaying the image with the selected mask picture to generate a masked image; and generating a projection beam corresponding to the masked image. Each of the at least one mask picture has at least one hollow portion. The masked image presents a portion of the image in an area corresponding to the at least one hollow portion.

To sum up, the projection device and the projection method of the present disclosure select a selected mask picture from at least one mask picture, and overlay an image with the selected mask picture to generate a masked image. The masked image presents the portion of the image in the area corresponding to the at least one hollow portion, so that the present disclosure may mask the image to provide diverse image output effects.

In order to make the above-mentioned features and advantages of the present disclosure more comprehensible, the following embodiments are described in detail in conjunction with the accompanying drawings.

### BRIEF DESCRIPTION OF THE DRAWINGS

FIG. 1 is a schematic diagram of a projection device according to an embodiment of the disclosure.

FIG. 2A and FIG. 2B are schematic diagrams of mask pictures according to an embodiment of the present disclosure.

FIG. 3 is a schematic diagram of zooming a mask picture according to an embodiment of the present disclosure.

FIG. 4A and FIG. 4B are respectively schematic diagrams of generating a masked image according to an embodiment of the present disclosure.

FIG. 5 is a schematic diagram of a projection device according to another embodiment of the disclosure.

FIG. 6 is a flowchart of a projection method according to an embodiment of the disclosure.

### DESCRIPTION OF THE EMBODIMENTS

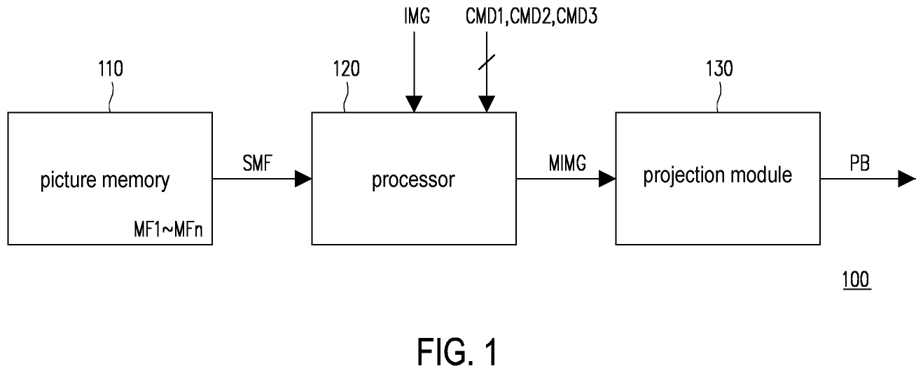

Please refer to FIG. 1. FIG. 1 is a schematic diagram of a projection device according to an embodiment of the present disclosure. In this embodiment, a projection device 100 includes a picture memory 110, a processor 120, and a projection module 130. The picture memory 110 stores mask pictures MF1 to MFn. The mask pictures MF1 to MFn respectively have one or more hollow portions. The picture memory 110 can be any type of memory device. The mask pictures MF1 to MFn can be different customized pictures. The picture memory 110 of the present disclosure may store one or more mask pictures, and is not limited to this embodiment.

In this embodiment, the processor 120 is coupled to an image memory 110. The processor 120 selects a mask picture from the mask pictures MF1 to MFn and uses it as a selected mask picture SMF. The processor 120 receives an image IMG. The image IMG may be a dynamic movie or a static picture. The processor 120 may receive the image IMG sent from the outside of the projection device 100 through interfaces such as VGA, DVI, HDMI, Display port, S-video, Video, etc, or, a storage medium provided in the projection device 100 may receive the image IMG, so that the projection device 100 may provide and play the projected image according to the image IMG. The processor 120 overlays the received image IMG with the selected mask picture SMF to generate a masked image MIMG.

For example, while the projection device 100 is providing a projected image corresponding to the image IMG, the processor 120 receives a selection command CMD1 and a mask command CMD2, and selects the selected mask picture SMF from the mask pictures MF1 to MFn in response to the selection command CMD1. The processor 120 also selects the selected mask picture SMF and overlays the image IMG in response to the mask command CMD2 to generate the masked image MIMG. For another example, the processor 120 may also overlay the currently unplayed image IMG with the selected mask picture SMF in response to the mask command CMD2 to generate the masked image MIMG. The processor 120 is, for example, a scaler, a central processing unit (CPU), other programmable general-purpose or special-purpose microprocessor, digital signal processor (DSP), programmable controller, application specific integrated circuit (ASIC), programmable logic device (PLD), other similar devices, or a combination of these devices, which can load and execute computer programs. In some embodiments, the operation of the processor 120 mentioned above are implemented by application software. The application software may generate the masked image MIMG in response to the user's operation.

For example, the formats of mask pictures MF1 to MFn are one of Portable Network Graphics (PNG), Graphics Interchange Format (GIF), and Scalable Vector Graphics (SVG), or it can be an opaque graphic. The PNG format supports the storage of transparency in at least one part of an image file. The part with transparency is the hollow portion mentioned above, and the part with opacity is the mask portion excluding the mentioned hollow portion. Therefore, a PNG image can be adopted as a mask picture. A GIF picture can be edited by software to produce one or more hollow portions. Therefore, GIF pictures can be adopted as mask pictures. At least a part of an SVG picture may be set to have transparency. The part with transparency is the hollow portion mentioned above, and the part with opacity is the mask portion. Therefore, SVG pictures can also be adopted as mask pictures. The present disclosure is not limited to these examples. The processor 120 may also perform format conversion or hollow/transparency editing on pictures in any format to convert the pictures into one of the mask pictures MF1 to MFn.

In this embodiment, the masked image MIMG presents the portion of the image IMG in the area corresponding to the hollow portion. Furthermore, the selected mask picture SMF has a hollow portion and a mask portion excluding the hollow portion. The mask portion masks part of the image IMG, whereas the hollow portion does not mask the image IMG. Therefore, the projected image corresponding to the masked image MIMG only presents the portion of the information of the image IMG in the area corresponding to the hollow portion without presenting the portion of the information in the image IMG that is masked.

In some embodiments, the processor 120 is further operated to remove the selected mask picture SMF to restore the masked image MIMG to the image IMG. For example, the processor 120 removes the selected mask picture SMF in response to a cancel command (not shown), so as to restore the masked image MIMG to the image IMG.

In this embodiment, the projection module 130 is coupled to the processor 120. The projection module 130 generates a projection beam PB corresponding to the masked image MIMG according to the masked image MIMG, so as to generate a projection image of the masked image MIMG.

It is worth mentioning here that the processor 120 overlays the image IMG with the selected mask picture SMF to generate the masked image MIMG. The masked image MIMG presents the portion of the image IMG in the area corresponding to the hollow portion, such that the projection device 100 may replace the image IMG or the selected masked picture SMF to generate a new masked image MIMG. In this way, when masking the image IMG, the projection device 100 may improve the convenience in generating the masked image MIMG and also provide diverse image output effects.

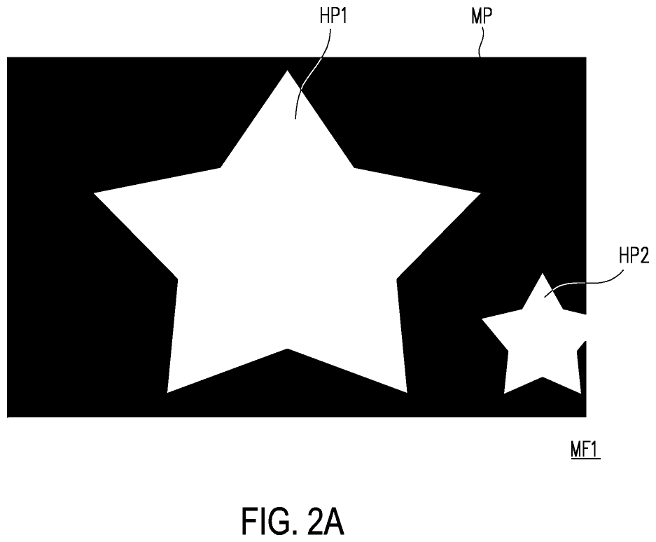

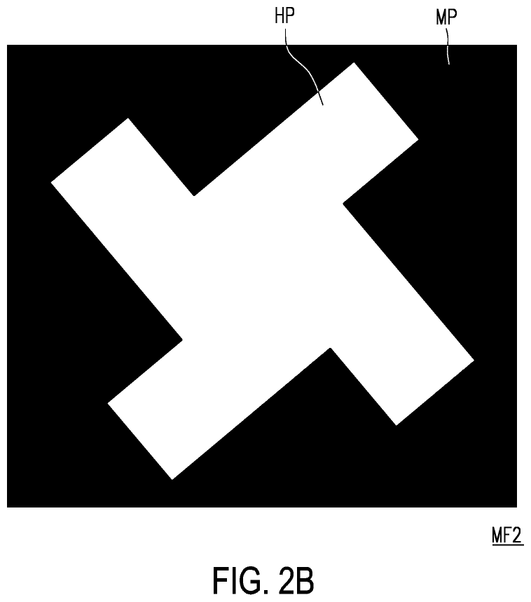

Please refer to FIG. 1 and FIG. 2A at the same time. FIG. 2A is a schematic diagram of a mask picture according to an embodiment of the present disclosure. In this embodiment, the mask picture MF1 includes, for example, a mask portion MP and hollow portions HP1 and HP2. In this embodiment, the shapes of the hollow portions HP1 and HP2 are, for example, a star pattern (the disclosure is not limited to this). The projection device 100 selects the mask picture MF1 (that is, using the mask picture MF1 as the selected mask picture SMF) and overlays the image IMG with the mask picture MF1, and part of the image IMG is covered by the mask portion MP. Therefore, the masked image MIMG generated by the projection device 100 only presents the unmasked portion of the image IMG in the hollow portions HP1 and HP2 without presenting the masked portion of the image IMG. In this embodiment, the mask portion MP is a fully black pattern. The mask portion MP of the present disclosure may include at least one single-color pattern or multi-color pattern, and the present disclosure is not limited to this embodiment.

Please refer to FIG. 1 and FIG. 2B at the same time. FIG. 2B is a schematic diagram of a mask picture according to an embodiment of the present disclosure. In this embodiment, a mask picture MF2 includes, for example, a mask portion MP and a hollow portion HP. In this embodiment, the hollow portion HP may be an irregular shape, such that the projection device 100 satisfies projection applications in irregular shapes, such as projection mapping in any shape. In addition, the projection device 100 may also replace applications like irregular splicing of multiple displays.

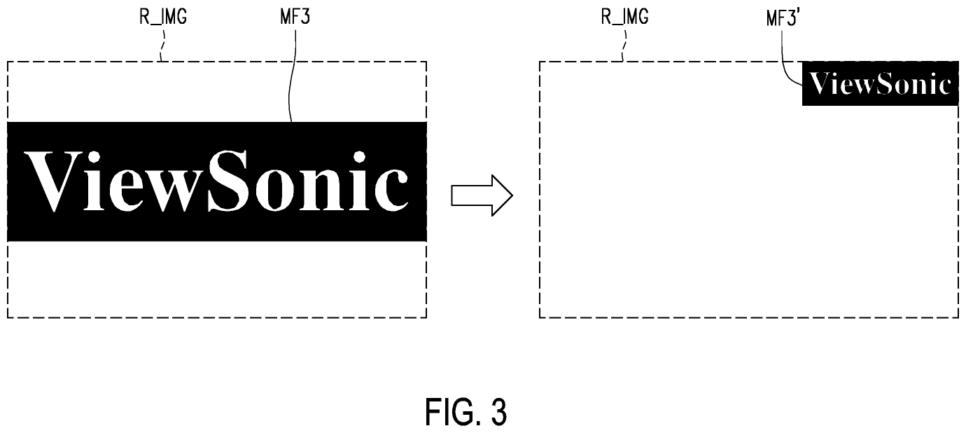

Please refer to FIG. 1 and FIG. 3 at the same time. FIG. 3 is a schematic diagram of zooming a mask picture according to an embodiment of the present disclosure. In this embodiment, the masked portions and the hollow portions of a mask picture MF3 show the word “ViewSonic.” In this embodiment, the processor 120 selects the mask picture MF3 from the mask pictures MF1 to MFn (that is, using the mask picture MF3 as the selected mask picture SMF) in response to the selection command CMD1. For example, the width of the mask picture MF3 is substantially equal to the width of a display range R_IMG of the image IMG (the disclosure is not limited to this). The processor 120 receives the zoom command CMD3, and reduces or enlarges the size of the selected mask picture MF3 (i.e., the selected mask picture SMF) in response to the zoom command CMD3, so as to generate the mask picture MF3′. In the example of FIG. 3, the mask picture MF3 is reduced to generate a mask picture MF3′. Therefore, the size of the mask picture MF3′ is significantly smaller than the display range R_IMG of the image IMG. In addition, the processor 120 also receives a movement command, and moves the mask image in response to the movement command. In this embodiment, the processor 120 may be operated to move the position of the mask picture MF3′ to a corner of the display range R_IMG. The mask picture MF3′ may be adopted as a watermark. The processor 120 may overlay the image IMG with the mask picture MF3′ in response to the mask command CMD2. In this way, the processor 120 may add this watermark (i.e., the mask image MF3′) to the image IMG, so that the masked image MIMG presents the portion of the image IMG in the area corresponding to the hollow portion and the range outside the mask picture MF3′ (i.e., the selected mask picture SMF that has been reduced). In addition, as the watermark has multiple hollow portions, the hollow portions still show part of the message of the image IMG. Therefore, the watermark provided by the projection device 100 may change along with the playback of the image IMG, providing a richer presentation of the watermarks.

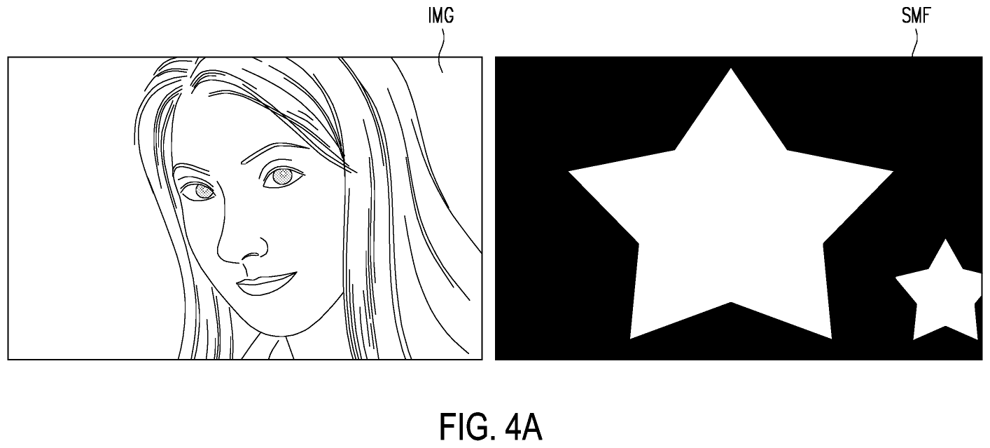

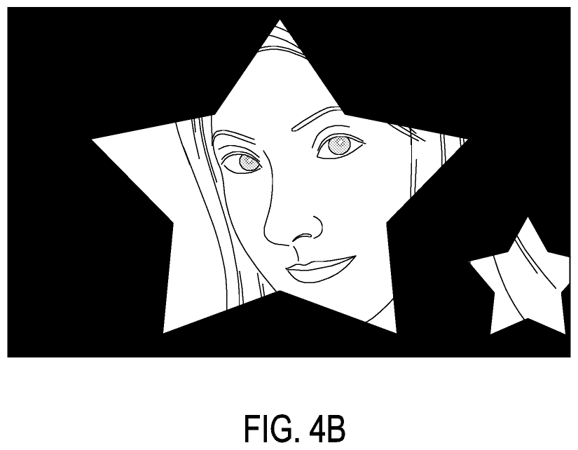

Take an example to demonstrate the generation of a masked image. Please refer to FIG. 1, FIG. 2A, FIG. 4A, and FIG. 4B at the same time. FIG. 4A and FIG. 4B are respectively schematic diagrams of generating a masked image according to an embodiment of the present disclosure. In this embodiment, the processor 120 selects the mask picture MF1 shown in FIG. 2A as the selected mask picture SMF and receives the image IMG, as shown in FIG. 4A. Next, the processor 120 overlays the image IMG with the selected mask picture SMF, so that the portion of the image IMG is covered by the mask portion MP of the selected mask picture SMF. Therefore, the masked image MIMG presents the unmasked portion of the image IMG in the hollow portions HP1 and HP2.

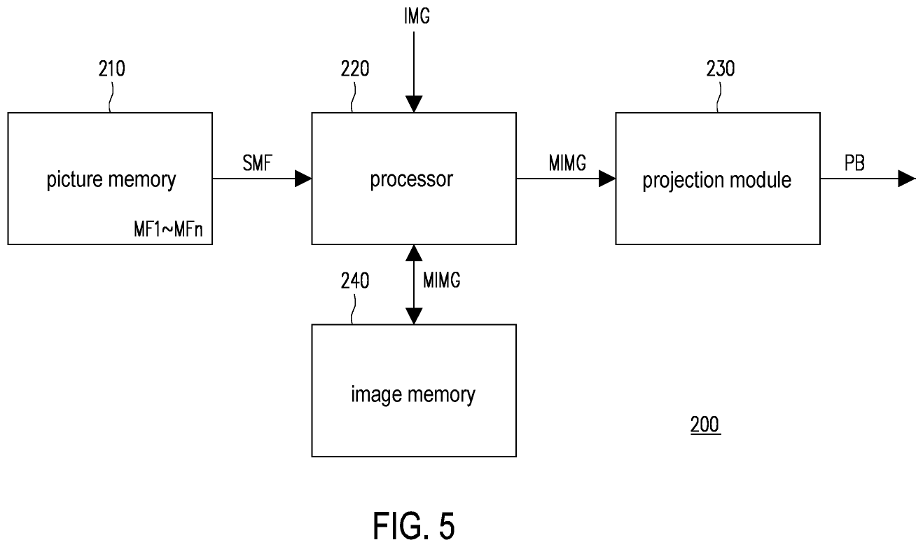

Please also refer to FIG. 5. FIG. 5 is a schematic diagram of a projection device according to another embodiment of the present disclosure. A projection device 200 includes a picture memory 210, a processor 220, a projection module 230, and an image memory 240. The image memory 240 is coupled to the processor 220. The processor 220 saves the masked image MIMG in the image memory 240. For example, the processor 220 uses the mask picture MF3 in FIG. 3 as the selected mask picture SMF, and overlays the image IMG with the selected mask picture SMF to generate the masked image MIMG, and the masked image MIMG is stored in the image memory 240. The masked image MIMG stored in the image memory 240 may be set as at least one of at least one of the power-on image, the power-off image, and the no-signal-source image of the projection device 200.

In this embodiment, since the implementation details of the cooperative operation among the picture memory 210, the processor 220, and the projection module 230 are sufficiently taught in the embodiments of FIG. 1 to FIG. 4B, they are not repeated herein.

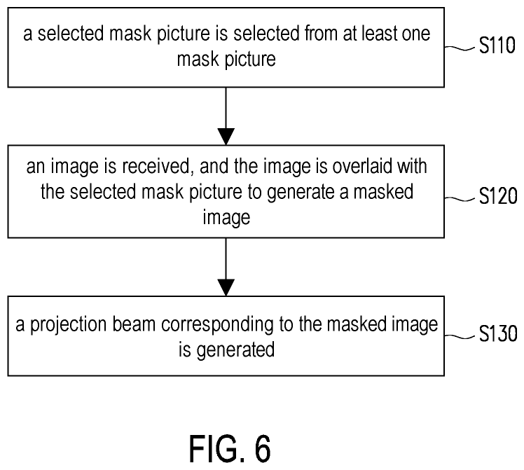

Please refer to FIG. 1 and FIG. 6 at the same time. FIG. 6 is a flowchart of a projection method according to an embodiment of the present disclosure. In this embodiment, the projection method includes steps S110 to S130. In step S110, the processor 120 selects the selected mask picture SMF from the mask pictures MF1 to MFn. Each of the mask pictures MF1 to MFn has at least one hollow portion. In step 5120, the processor 120 receives the image IMG and overlays the image IMG with the selected mask picture SMF to generate the masked image MIMG. The masked image MIMG presents the portion of the image IMG in the area corresponding to the hollow portion. In step 5130, the projection module 130 generates the projection beam PB corresponding to the masked image MIMG. Since the implementation details of steps S110 to S130 are sufficiently taught in the various embodiments shown in FIG. 1 to FIG. 4B, they are not repeated herein. It should be understood that the projection method shown in FIG. 6 can also be applied to the projection device 200 shown in FIG. 5.

To sum up, the projection device and the projection method of the present disclosure overlay the image with the selected mask picture to generate the masked image. The masked image presents the portion of the image in the area corresponding to the hollow portion. Therefore, the present disclosure may improve the convenience in generating the masked image and also provide diverse image output effects. The present disclosure may be applied to projection mapping in any shape, the replacement of irregular splicing effects of multiple displays, watermark design, and the creation of images suitable for the projection device in a specific state (for example, at least one of the power-on image, the power-off image, and the no-signal-source image).

Although the present disclosure has been disclosed in the above embodiments, it is not intended to limit the present disclosure. Anyone with ordinary knowledge in the technical field can make some changes and modifications without departing from the spirit and scope of the present disclosure. The scope of protection of the present disclosure shall be subject to those defined by the attached patent scope.

What is claimed is:

1. A projection device, comprising:
a picture memory, configured to store at least one mask picture, wherein each of the at least one mask picture has at least one hollow portion;
a processor, coupled to the picture memory, and configured to select a selected mask picture from the at least one mask picture, receive an image, and overlay the image with the selected mask picture to generate a masked image, wherein the masked image presents a portion of the image in an area corresponding to the at least one hollow portion; and
a projection module, coupled to the processor, and configured to generate a projection beam corresponding to the masked image.

2. The projection device according to claim 1, wherein the processor selects the selected mask picture from the at least one mask picture in response to a selection command.

3. The projection device according to claim 1, wherein:
the processor zooms a size of the selected mask picture in response to a zoom command, and
the masked image presents a portion of the image in the area corresponding to the at least one hollow portion and a range outside the selected mask picture reduced.

4. The projection device according to claim 1, wherein:
the processor moves the selected mask picture in response to a movement command.

5. The projection device according to claim 1, wherein the processor generates the masked image in response to a mask command.

6. The projection device according to claim 1, wherein the processor removes the selected mask picture in response to a cancel command to restore the masked image to the image.

7. The projection device according to claim 1, further comprising:
an image memory, coupled to the processor,
wherein the processor saves the masked image in the image memory.

8. The projection device according to claim 1, wherein a format of each of the at least one mask picture is one of Portable Network Graphics, Graphics Interchange Format, and Scalable Vector Graphics.

9. The projection device according to claim 1, wherein a format of each of the at least one mask picture is an opaque graphic.

10. A projection method, comprising:
selecting a selected mask picture from at least one mask picture;
receiving an image, and overlaying the image with the selected mask picture to generate a masked image; and
generating a projection beam corresponding to the masked image,
wherein each of the at least one mask picture has at least one hollow portion, and the masked image presents a portion of the image in an area corresponding to the at least one hollow portion.

11. The projection method according to claim 10, wherein selecting the selected mask picture from the at least one mask picture comprises:
selecting the selected mask picture from the at least one mask picture in response to a selection command.

12. The projection method according to claim 10, wherein selecting the selected mask picture from the at least one mask picture comprises:
zooming a size of the selected mask picture in response to a zoom command,
wherein the masked image presents a portion of the image in the area corresponding to the at least one hollow portion and a range outside the selected mask picture reduced.

13. The projection method according to claim 10, wherein selecting the selected mask picture from the at least one mask picture comprises:
moving the selected mask picture in response to a movement command.

14. The projection method according to claim 10, wherein overlaying the image with the selected mask picture to generate the masked image comprises:
generating the masked image in response to a mask command.

15. The projection method according to claim 10, wherein overlaying the image with the selected mask picture to generate the masked image comprises:
removing the selected mask picture in response to a cancel command to restore the masked image to the image.

16. The projection method according to claim 10, further comprising:
saving the masked image.

17. The projection method according to claim 10, wherein a format of each of the at least one mask picture is one of Portable Network Graphics, Graphics Interchange Format, and Scalable Vector Graphics.

18. The projection method according to claim 10, wherein a format of each of the at least one mask picture is an opaque graphic.
